(19) United States
(12) Patent Application Publication
(10) Pub. No.: US 2007/0115380 A1
(43) Pub. Date: May 24, 2007

(54) Solid-state image pickup device

(75) Inventors: Ikuya Shibata, Osaka (JP); Sei Suzuki, Osaka (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/594,083

(22) Filed: Nov. 8, 2006

(30) Foreign Application Priority Data
Nov. 22, 2005 (JP) 2005-336561
Sep. 6, 2006 (JP) 2006-240893

(51) Int. Cl. H04N 3/14; H04N 5/335

(52) U.S. Cl. 348/311

(57) ABSTRACT

A solid-state image pickup device is provided which causes no image degradation in the high-speed driving of the horizontal shift register. A charge transfer path (1) of a horizontal shift register is branched into two at a certain angle (θ) on the adjacent electrode parts of the final stage of the horizontal shift register. Next to the electrode (H1) which forms the branching of the charge transfer path (1), a pair of transfer electrodes in which an electrode (2) of a first layer and an electrode (3) of a second layer are connected are disposed on the charge transfer paths 1 like the horizontal shift register before branching, so that transfer electrodes (HLa and HLb) of the horizontal shift register of the charge transfer path (1) are formed.

### FIELD OF THE INVENTION

The present invention relates to a solid-state image pickup device used for a video camera, an image input apparatus, and so on.

### BACKGROUND OF THE INVENTION

FIG. 10 is a plan view showing a horizontal shift register in a conventional solid-state image pickup device described in JP04-223373A.

Generally, in a horizontal shift register of a solid-state image pickup device in a CCD (Charge Coupled Device), an electrode 2 of a first layer formed of a material such as polysilicon and an electrode 3 of a second layer formed of polysilicon partially overlap each other in plan view on a charge transfer path 1 formed on a semiconductor substrate. The electrodes are displaced from each other and intersect the charge transfer path 1 at right angles. The electrode 2 of the first layer and the electrode 3 of the second layer are electrically insulated from each other by an insulating film.

Further, the electrodes 2 of the first layer are connected to the adjacent electrodes 3 of the second layer such that a pair of transfer electrodes H1 and H2 is formed.

Under the electrode 3 of the second layer, a p-type impurity area is formed which makes a potential under the electrode 3 of the second layer higher than a potential under the electrode 2 of the first layer, thereby forming a potential barrier.

An output gate 4 which is formed of polysilicon and fed with a voltage VOG is disposed next to the final stage of the horizontal shift register.

The subsequent stage of the output gate 4 includes an output part 6 for converting transferred charge to voltage, a drain part 10 fixed at an electric potential Vd, and a reset gate 8 which is fed with a reset clock pulse to discharge charge to the drain part.

FIG. 11 shows an example of the drive clock pulse of the horizontal shift register in the solid-state image pickup device of FIG. 10.

Potentials under the transfer electrodes H1 and H2 are controlled by applying clock pulses of opposite phases alternately to the transfer electrode H1 and the transfer electrode H2, thereby achieving charge transfer with a two-phase clock. In FIG. 11, charge indicated by shading is transferred from right to left.

Charge transferred to the final stage of the horizontal shift register flows to the output part 6 through the output gate 4, and is converted to voltage.

Thereafter, a potential under the reset gate 8 is reduced by applying H (high) level clock to the reset gate 8, and the charge of the output part 6 is discharged to the drain part 10.

In recent years, as CCDs have increased in pixel density, clock pulses with faster frequencies have been required for horizontal shift registers. When the horizontal shift register of the solid-state image pickup device described in JP04-223373A is driven at, for example, a high-speed frequency of 30 MHz or higher, the configuration of the horizontal shift register is affected by the frequency characteristics or the like of an output circuit included in the solid-state image pickup device, so that the characteristics of the solid-state image pickup device are limited.

In response to this problem, JP59-122180A discloses a solid-state image pickup device in which a plurality of horizontal shift registers are formed each being configured as shown in FIG. 10. During charge transfer from a vertical shift register to the horizontal shift registers, transferred charge is allocated to the horizontal shift registers, so that the driving frequencies of the horizontal shift registers can be reduced.

The solid-state image pickup device described in JP59-122180A has a first problem in which a large area is necessary for the configuration of the solid-state image pickup element because of the plurality of horizontal shift registers.

Moreover, the solid-state image pickup device has a second problem of the difficulty of making uniform the characteristics of the plurality of horizontal shift registers. Unevenness in characteristics such as transfer efficiency causes a problem in picture quality.

In view of the problems, an object of the present invention is to provide a solid-state image pickup device which does not require a large area to constitute the solid-state image pickup device and does not cause image degradation resulted from unevenness in the characteristics of horizontal shift registers.

### DISCLOSURE OF THE INVENTION

In order to solve the problems, a solid-state image pickup device of the present invention includes a plurality of light receiving parts which are laid out in a matrix and generate charge through photoelectric conversion, vertical shift registers which transfer the charge and are arranged in a plurality of vertical rows, a horizontal shift register for horizontally transferring the charge having been transferred from the vertical shift registers, and an output part for outputting the charge having been transferred from the horizontal shift register, wherein the horizontal shift register is branched and includes the plurality of output parts disposed on the horizontal shift register.

According to the solid-state image pickup device of the present invention, the horizontal shift register includes a transfer electrode disposed between the output part and a branch point where the horizontal shift register starts branching.

The solid-state image pickup device of the present invention includes a transfer electrode disposed between the output part and a branch point where the horizontal shift register starts branching, and another transfer electrode disposed on one of branched charge transfer paths.

According to the solid-state image pickup device of the present invention, the horizontal shift register includes a charge transfer path tapering down from a branch point to an output gate.

According to the solid-state image pickup device of the present invention, the horizontal shift register includes common wiring of a clock pulse for discharging charge having been detected in the output part.

According to the solid-state image pickup device of the present invention, the horizontal shift register includes a charge transfer path branched into two on a transfer electrode adjacent to a transfer electrode of the final stage of the horizontal shift register.

The configuration of the present invention includes the single horizontal shift register, causing no image degradation caused by unevenness of the horizontal shift register.

Further, the transfer paths under transfer electrodes HLa and HLb of the final stage taper down to the output gates, so that any problems do not occur due to charge remaining after transfer.

Wiring connected to the reset gates is made uniform. Thus the same clock pulse is applied to the reset gates and the output parts are affected by noise or the like in a similar manner, thereby minimizing variations in output voltage.

Further, the charge transfer path is branched into two on the transfer electrode adjacent to the transfer electrode of the final stage of the horizontal shift register, so that the characteristics of the horizontal shift register can be made even.

### BRIEF DESCRIPTION OF THE DRAWINGS

FIG. 1 is a plan view showing a part of the configuration of a solid-state image pickup device according to an embodiment of the present invention;

FIG. 2 is a plan view showing the configuration of a horizontal shift register in the solid-state image pickup device according to Embodiment 1 of the present invention;

FIG. 3 is a chart showing the driving timing of the solid-state image pickup device according to Embodiment 1 of the present invention;

FIG. 4 is an explanatory drawing showing an example of a potential in cross section A-X of FIG. 2;

FIG. 5 is an explanatory drawing showing an example of a potential in cross section B-X of FIG. 2;

FIG. 6 is a plan view showing the configuration of a horizontal shift register in a solid-state image pickup device according to Embodiment 2 of the present invention;

FIG. 7 is a chart showing the driving timing of the solid-state image pickup device according to Embodiment 2 of the present invention;

FIG. 8 is an explanatory drawing showing an example of a potential in cross section A-X of FIG. 6;

FIG. 9 is an explanatory drawing showing an example of a potential in cross section B-X of FIG. 6;

FIG. 10 is a plan view showing a horizontal shift register in a conventional solid-state image pickup device; and

FIG. 11 is a diagram showing an example of a potential of the conventional solid-state image pickup device.

### DESCRIPTION OF THE EMBODIMENTS

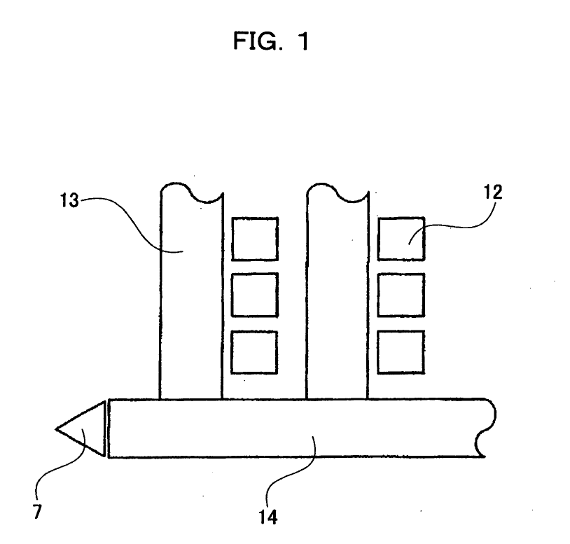

With reference to the accompanying drawings, a solid-state image pickup device will now be described according to embodiments of the present invention. FIG. 1 is a structural diagram showing a part of the solid-state image pickup device of the present invention.

The solid-state image pickup device of the present invention has a plurality of light receiving parts 12 which are formed and laid out in a matrix on a semiconductor substrate to convert light to charge, vertical shift registers 13 which are arranged in two or more vertical rows adjacent to the light receiving parts 12 to transfer charge having been converted in the light receiving parts 12, a horizontal shift register 14 which receives charge having been transferred from the vertical shift registers 13 and transfers the charge to an output part 7, and the output part 7 which converts the charge having been transferred from the horizontal shift register 14 to voltage.

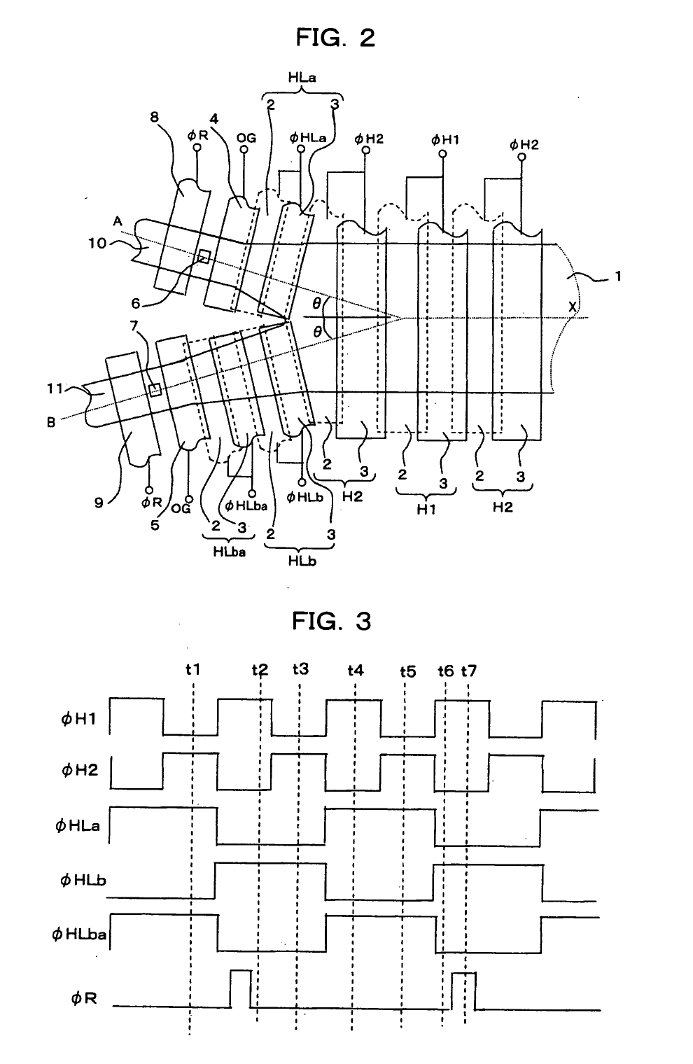

FIG. 2 is a plan view showing the solid-state image pickup device according to the embodiment of the present invention. FIG. 2 particularly shows the horizontal shift register.

An electrode 2 of a first layer formed of a material such as polysilicon and an electrode 3 of a second layer formed of a material such as polysilicon partially overlap each other on a charge transfer path 1 formed on the semiconductor substrate. The electrode 2 of the first layer and the electrode 3 of the second layer are electrically insulated from each other by an insulating film.

Further, the electrodes 2 of the first layer are connected to the adjacent electrodes 3 of the second layer such that a pair of transfer electrodes H1 and H2 is formed.

Under the electrode 3 of the second layer, a p-type impurity area (not shown) is formed which makes a potential under the electrode 3 of the second layer higher than a potential under the electrode 2 of the first layer, thereby forming a potential barrier.

The charge transfer path 1 of the horizontal shift register is branched into two at a certain angle θ on the adjacent electrode parts of the final stage of the horizontal shift register 14. In other words, in the area of the transfer electrode H2 on the terminal end of the charge transfer path 1, the center line of the charge transfer path 1 is branched at an angle of 2θ in one direction (upward in FIG. 2) and the other direction (downward in FIG. 2). The charge transfer path 1 is disposed along the branched center lines.

At this point, the angle θ for branching the transfer path of the horizontal shift register is set at random within 90 degrees. Any angle within the permissible range of the design layout of a CCD may be used except for an obtuse angle.

The branched charge transfer paths 1 taper down from the transfer electrode H2, which serves as a branch point, toward output gates 4 and 5, respectively. To be specific, the base ends of the branched paths decrease in width toward the front ends of the output gates 4 and 5 from the rear end of the electrode 2 of the first layer in the transfer electrode H2 serving as the branch point, and the branched paths have an equal width from the front ends of the output gates 4 and 5.

Further, next to the electrode 2 of the first layer in the electrode H2 serving as the base point of the branching of the charge transfer path 1, like the horizontal shift register 14 before branching, transfer electrodes HLa and HLb in which the electrode 2 of the first layer and the electrode 3 of the second layer are connected are disposed on the charge transfer path 1 so as to intersect at right angles the branched center lines of the charge transfer path 1, so that the transfer electrodes HLa and HLb are formed in the final stage of the horizontal shift register 14 of the charge transfer path 1.

Moreover, a transfer electrode is disposed on one of the branched charge transfer paths 1. To be specific, as shown in FIG. 2, a transfer electrode HLba is disposed between the rear end of the electrode HLb on the lower branched path and the front end of the output gate 5.

The transfer electrode HLba is also formed so as to intersect the branched center line of the charge transfer path 1 at a right angle.

Clock pulses φHLa and φHLb are applied to the transfer electrodes HLa and HLb, respectively. The same clock pulse as the clock pulse φHLa is applied to the transfer electrode HLba.

The electrode 2 of the first layer in the electrode H2, which serves as the base point of the branch, has a rear end intersecting the branched center lines of the charge transfer path 1 at right angles, and the rear end is formed as a side end bending at an obtuse angle.

The output gates 4 and 5 fixed at an electric potential VOG are adjacent to the transfer electrodes HLa and HLba, respectively.

The output gates 4 and 5 also intersect the center lines of the charge transfer path 1 at right angles.

Further, output parts 6 and 7 for converting transferred charge to voltage are disposed in the subsequent stage of the output gates 4 and 5 of the charge transfer path 1. Moreover, respectively on the terminal ends of the charge transfer path, drain parts 10 and 11 fixed at an electric potential Vd are disposed and reset gates 8 and 9 fed with reset clock pulses for discharging transferred charge to the drain parts 10 and 11 are disposed.

Wiring connected to the reset gates 8 and 9 is made uniform.

As described above, the solid-state image pickup device according to the embodiment of the present invention has a structural characteristic in that the branch is made at the certain angle θ on the adjacent electrode parts of the final stage of the single horizontal shift register and the two output parts 6 and 7 are disposed respectively on the branched charge transfer paths.

Further, in the solid-state image pickup device according to the embodiment of the present invention, charge can be transferred even when a clock pulse has a low effective value in the horizontal shift register 14. In a small solid-state image pickup device, each of the transfer electrodes of the horizontal shift register 14 has a short transfer path length, and thus even when a potential difference is small, charge hardly remains after transfer.

Therefore, the single horizontal shift register 14 is enough in this configuration, reducing an area necessary for the configuration of the solid-state image pickup device.

Moreover, the transfer electrode HLba can be added to the other charge transfer path (upward in FIG. 2). In this case, a transfer electrode made up of the electrodes 2 and 3 is disposed between the rear end of the transfer electrode HLa and the front end of the output gate 4 so as to intersect the branched center line of the upper charge transfer path 1 at a right angle.

At this point, the same clock pulse as the clock pulse φHLb is applied to the transfer electrode.

Referring to FIGS. 3, 4 and 5, the following will discuss the operations of the horizontal shift register in the solid-state image pickup device of the present invention.

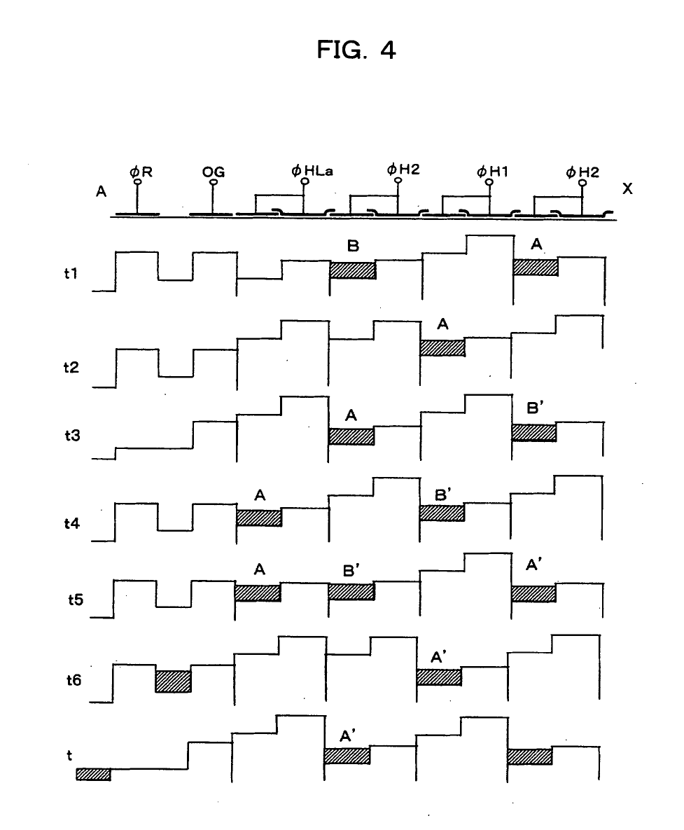

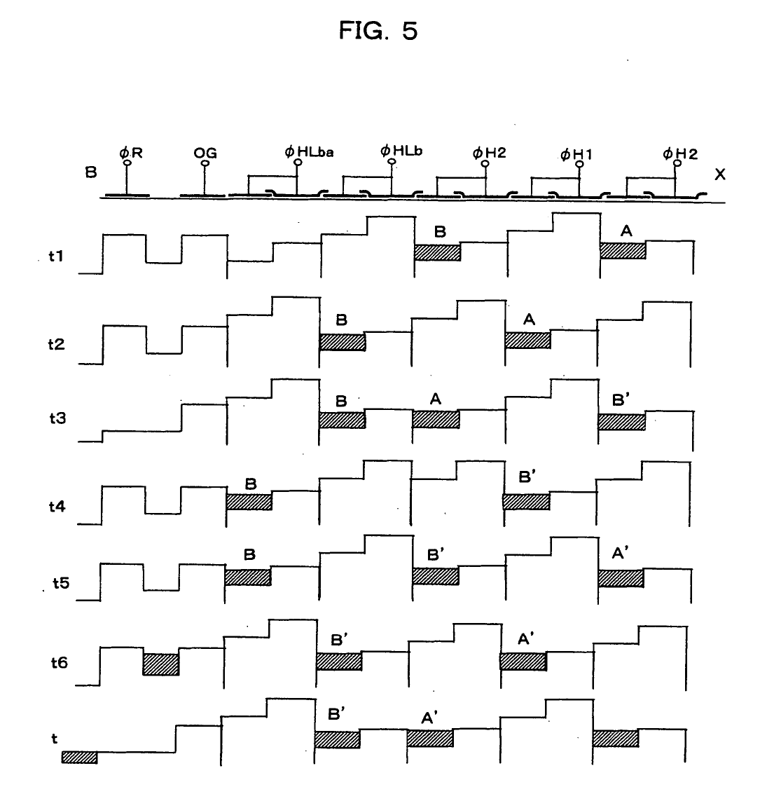

FIG. 3 shows an example of the driving timing of the horizontal shift register 14 in the solid-state image pickup device according to the embodiment of the present invention. FIG. 4 shows a potential profile in cross section A-X of FIG. 2. FIG. 5 shows a potential profile in cross section B-X of FIG. 2.

Potentials under the transfer electrodes are controlled by applying clock pulses of opposite phases alternately to the transfer electrodes H1 and H2 of the horizontal shift register, thereby achieving charge transfer with a two-phase clock.

At time t1, φH2 is set at H (high) level and charge B having been transferred through the horizontal shift register 14 is accumulated in a storage area under the electrode H2 serving as the branch point.

At time t2, φHLa is set at L (low) level and φHLb is set at H level. Thus the potential under the electrode HLb decreases. Since φH2 is set at L level, the potential level under the electrode H2 increases and the transfer charge B is transferred to a storage area under the electrode HLb.

At time t3, φHLa remains at L level and φHLb remains at H level. Since φH2 is set at H level, charge A having been transferred through the horizontal shift register is transferred to the storage area under the electrode H2 serving as the branch point.

At time t4, φHLa is set at H level and φHLb is set at L level. Thus the potential under the electrode HLa decreases and the potential under the electrode φHLb increases. At this point, φH2 is set at L level and thus the transfer charge A is transferred to a storage area under the electrode HLa. Since φHLba is set at H level and the potential under the electrode HLba decreases, the transfer charge B is transferred to a storage area under the electrode HLBa.

At time t5, φHLa remains at H level and φHLb remains at L level. Since φH2 is set at H level, charge B′ having been transferred through the horizontal shift register 14 is transferred to the storage area under the electrode H2 serving as the branch point.

At time t6, φHLa and φHLba are both set at L level. Thus the potentials under the electrodes HLa and HLba increase, the transfer charge A is transferred to the output part 6, and the transfer charge B is transferred to the output part 7.

At this point, φHLb is set at H level and the potential under the electrode HLb decreases. Since φH2 is set at L level, the potential under the electrode H2 increases and the transfer charge B′ is transferred to the storage area under the electrode HLb.

At time t7, φR is set at H level and potentials under the reset gates 8 and 9 decrease. Thus the transfer charge A of the output part 6 is discharged to the drain part 10 and the transfer charge B of the output part 7 is discharged to the drain part 11.

By repeating a series of operations, the potential of the final stage of the horizontal shift register 14 is controlled, so that transfer charge can be allocated alternately to the output parts 6 and 7.

Since transfer charge is allocated by controlling the potential of the final stage of the horizontal shift register 14, the driving clock frequency of the final stage can be made slow and time for charge transfer from the final stage to the output parts 6 and 7 increases, reducing charge remaining after transfer.

Additionally, the charge transfer path tapers down toward the output gates 4 and 5, so that charge remaining after transfer can be further avoided and abnormal picture quality caused by remaining charge can be reduced.

Further, the operations of the output parts 6 and 7 can be reduced in speed, eliminating a limit imposed by the frequency characteristics of the output circuit.

Since the same reset clock pulse is applied to the reset gates 8 and 9, the same reset clock pulse affects signals converted from the output parts 6 and 7, so that a subtle difference is hard to occur between the signals and abnormal picture quality can be reduced.

Another embodiment of the present invention will be described below.

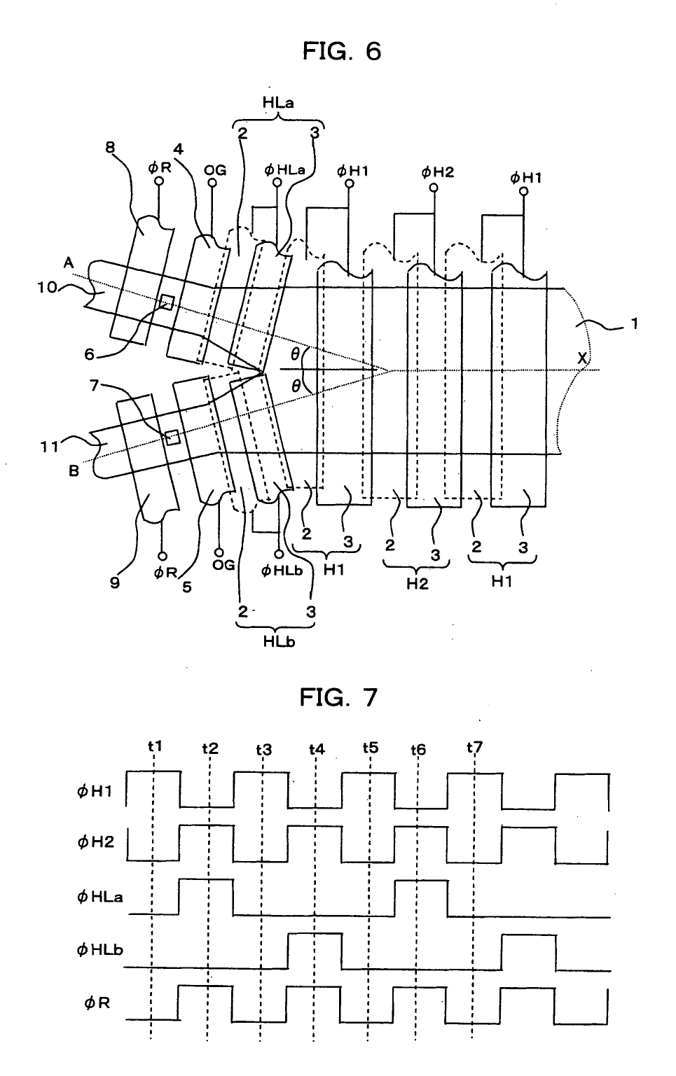

FIG. 6 is a partial plan view showing a solid-state image pickup device according to the embodiment of the present invention. FIG. 6 particularly shows a horizontal shift register.

An electrode 2 of a first layer formed of a material such as polysilicon and an electrode 3 of a second layer formed of a material such as polysilicon partially overlap each other on a charge transfer path 1 formed on a semiconductor substrate. The electrode 2 of the first layer and the electrode 3 of the second layer are electrically insulated from each other by an insulating film.

Further, the electrode 2 of the first layer is connected to the adjacent electrode 3 of the second layer such that a pair of transfer electrodes H1 and H2 is formed.

Under the electrode 3 of the second layer, a p-type impurity area (not shown) is formed which makes a potential under the electrode 3 of the second layer higher than a potential under the electrode 2 of the first layer, thereby forming a potential barrier.

The charge transfer path 1 of the horizontal shift register is branched into two at a certain angle θ on the adjacent electrode parts of the final stage of the horizontal shift register 14. In other words, in the area of the transfer electrode H1 on the terminal end of the charge transfer path 1, the center line of the charge transfer path 1 is branched at an angle of 2θ in one direction (upward in FIG. 6) and the other direction (downward in FIG. 6). The charge transfer path 1 is disposed along the branched center lines.

At this point, the angle for branching the transfer path of the horizontal shift register is set at random within 90 degrees. Any angle within the permissible range of the design layout of a CCD may be used except for an obtuse angle.

The branched charge transfer paths 1 taper down from the transfer electrode H1, which serves as a branch point, toward output gates 4 and 5, respectively. To be specific, the base ends of the branched paths decrease in width toward the front ends of the output gates 4 and 5 from the rear end of the electrode 2 of the first layer in the transfer electrode H1 serving as the branch point, and the branched paths have an equal width from the front ends of the output gates 4 and 5.

Further, next to the electrode 2 of the first layer in the electrode H1 serving as the branch point of the charge transfer path 1, like the horizontal shift register 14 before branching, transfer electrodes HLa and HLb to which the electrode 2 of the first layer and the electrode 3 of the second layer are connected are disposed on the charge transfer path 1 so as to intersect at right angles the branched center lines of the charge transfer path 1, so that the transfer electrodes HLa and HLb are formed in the final stage of the horizontal shift register 14 of the charge transfer path 1.

Clock pulses φHLa and φHLb are applied respectively to the transfer electrodes HLa and HLb of the final stage.

The electrode 2 of the first layer in the electrode H1, which serves as the base point of the branch, has a rear end intersecting the branched center lines of the charge transfer path 1 at right angles, and the rear end is formed as a side end bending at an obtuse angle.

The output gates 4 and 5 fixed at an electric potential VOG are adjacent to the transfer electrodes HLa and HLb of the final stage.

The output gates 4 and 5 also intersect the center lines of the charge transfer path 1 at right angles.

Further, output parts 6 and 7 for converting transferred charge to voltage are disposed in the subsequent stage of the output gates 4 and 5 of the charge transfer path 1. Moreover, respectively on the terminal ends of the charge transfer path, drain parts 10 and 11 fixed at an electric potential Vd are disposed and reset gates 8 and 9 fed with reset clock pulses for discharging transferred charge to the drain parts 10 and 11 are disposed.

Wiring connected to the reset gates 8 and 9 is made uniform.

As described above, the solid-state image pickup device according to the embodiment of the present invention has a structural characteristic in that the branch is made at the certain angle θ on the adjacent electrode parts of the final stage of the single horizontal shift register and the two output parts 6 and 7 are disposed respectively on the branched charge transfer paths.

Further, in the solid-state image pickup device according to the embodiment of the present invention, charge can be transferred even when a clock pulse has a low effective value in the horizontal shift register 14. In a small solid-state image pickup device, each of the transfer electrodes of the horizontal shift register 14 has a short transfer path length, and thus even when a potential difference is small, charge hardly remains after transfer.

Therefore, the single horizontal shift register 14 is enough in this configuration, reducing an area necessary for the configuration of the solid-state image pickup device.

Referring to FIGS. 7, 8 and 9, the following will discuss the operations of the horizontal shift register in the solid-state image pickup device of the present invention.

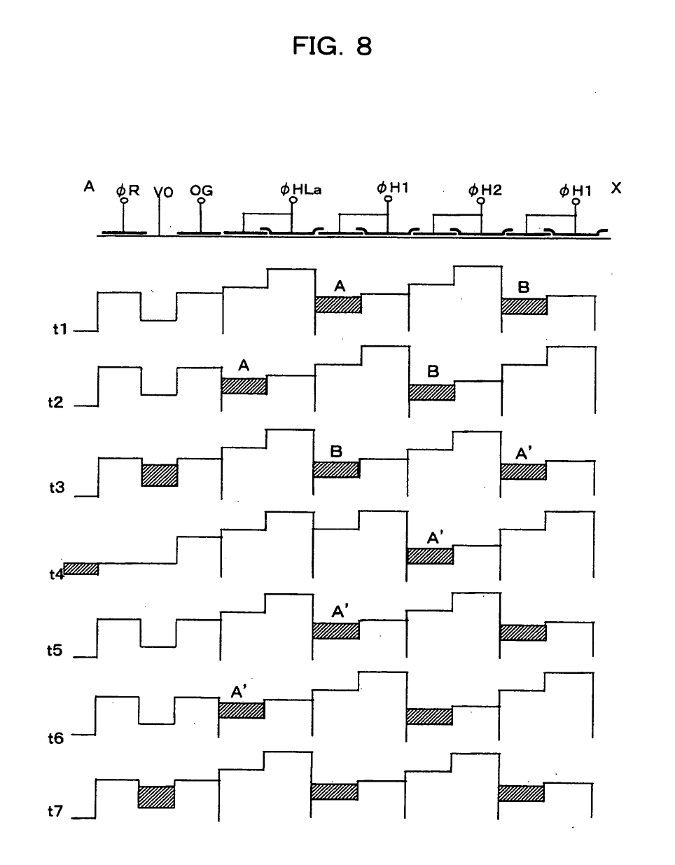

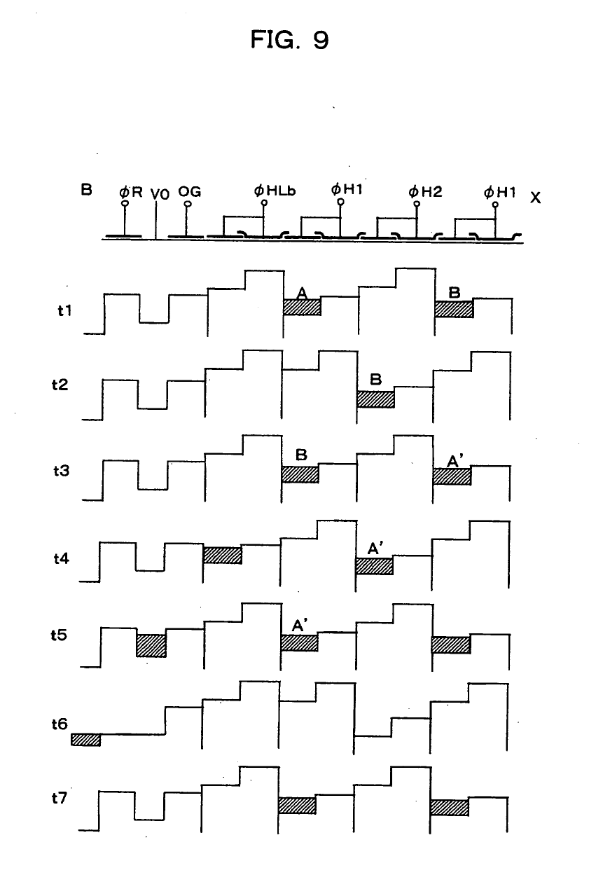

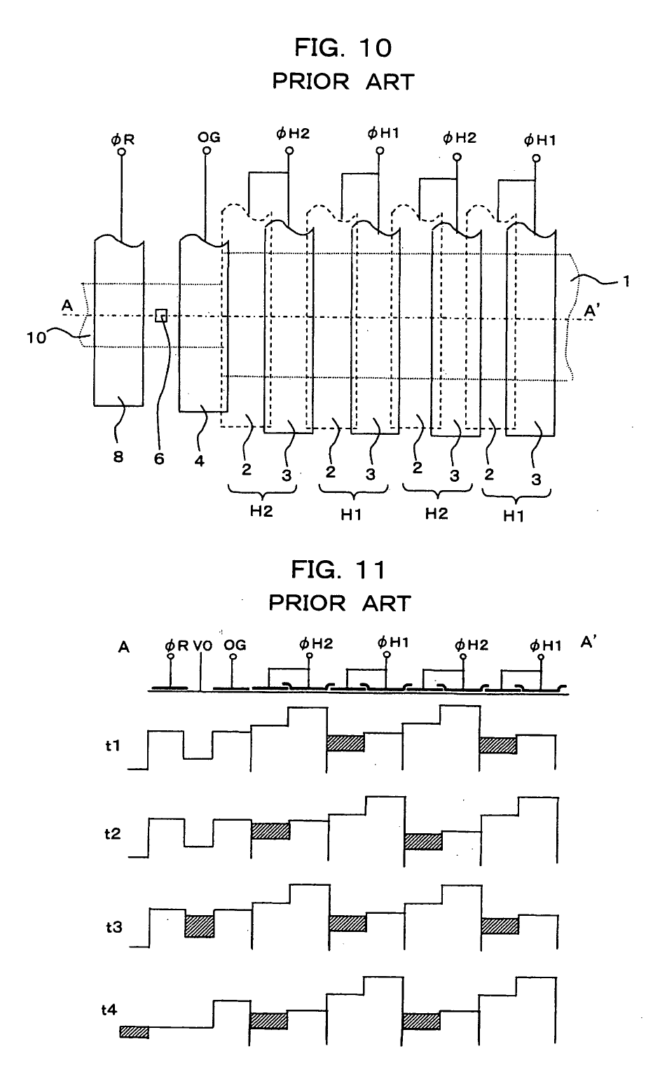

FIG. 7 shows an example of the driving timing of the horizontal shift register in the solid-state image pickup device of the present invention. FIG. 8 shows a potential profile in cross section A-X of FIG. 6. FIG. 9 shows a potential profile in cross section B-X of FIG. 6.

Potentials under the transfer electrodes H1 and H2 are controlled by applying clock pulses of opposite phases alternately to the transfer electrodes H1 and H2 of the horizontal shift register 14, there by achieving charge transfer with a two-phase clock.

At time t1, φHLa and φHLb are both set at L (low) level and charge A transferred through the horizontal shift register 14 is accumulated in a storage area under the gate H1 in the previous stage of the final stage.

At time t2, φHL1 is set at L level. Further, φHLa is set at H (high) level and φHLb is set at L level. Thus the potential under the electrode HLa decreases. Since the potential under the electrode HLb remains high, the transfer charge A is allocated and transferred to the storage area under the electrode HLa.

At time t3, φHLa is set at L level and the transfer charge A is transferred to the output part 6 through the output gate 4. At this point, since φHLb remains L level, the transfer charge B of the subsequent bit is accumulated in the storage area under the gate H1 in the previous stage of the final stage.

At time t4, φHLa is set at L level and φHLb is set at H level. Thus the potential under the electrode HLb decreases and the transfer charge B is transferred to a storage area under the electrode HLb.

A reset pulse at H level is applied to the reset gate 8, so that the transfer charge A of the output part 6 is discharged to the drain part 10.

At time t5, φHLb is set at L level and the transfer charge B is transferred to the output part 7 through the output gate 5. At this point, since φHLa remains L level, the transfer charge of two bits later is accumulated in the storage area under the gate H1 in the previous stage of the final stage.

At time t6, φHLa is set at H level and φHLb is set at L level. Thus transfer charge A′ is allocated and transferred to a storage area under the gate HLa.

A reset pulse at H level is applied to the reset gate 9, so that the transfer charge B of the output part 7 is discharged to the drain part 11.

By repeating a series of operations, the potential of the final stage of the horizontal shift register 14 is controlled, so that transfer charge can be allocated alternately to the output parts 6 and 7.

Since transfer charge is allocated by controlling the potential of the final stage of the horizontal shift register 14, the driving clock frequency of the final stage can be made slow and time for charge transfer from the final stage to the output parts 6 and 7 increases, reducing charge remaining after transfer.

Additionally, the charge transfer path 1 tapers down toward the output gates 4 and 5, so that charge remaining after transfer can be further avoided and abnormal picture quality caused by remaining charge can be reduced.

Since the same reset clock pulse is applied to the reset gates 8 and 9, the same reset clock pulse affects signals converted from the output parts 6 and 7, so that a subtle difference is hard to occur between the signals and abnormal picture quality can be reduced.

As described above, the solid-state image pickup device of the present invention prevents image degradation caused by high-speed driving of the horizontal shift register and thus the solid-state image pickup device is useful for a video camera, an image input apparatus, and so on.

What is claimed is:

1. A solid-state image pickup device, comprising:
a plurality of light receiving parts which are laid out in a matrix and generate charge through photoelectric conversion,
vertical shift registers which transfer the charge and are arranged in a plurality of vertical rows,
a horizontal shift register for horizontally transferring the charge having been transferred from the vertical shift registers, and
an output part for outputting the charge having been transferred from the horizontal shift register,
wherein the horizontal shift register is branched and includes the plurality of output parts disposed on the horizontal shift register.

2. The solid-state image pickup device according to claim 1, wherein the horizontal shift register includes a transfer electrode disposed between the output part and a branch point where the horizontal shift register starts branching.

3. The solid-state image pickup device according to claim 1, wherein the horizontal shift register further includes a transfer electrode disposed between the output part and a branch point where the horizontal shift register starts branching, and another transfer electrode disposed on one of branched charge transfer paths.

4. The solid-state image pickup device according to claim 1, wherein the horizontal shift register includes a charge transfer path tapering down from a branch point to an output gate.

5. The solid-state image pickup device according to claim 1, wherein the horizontal shift register includes common wiring of a clock pulse for discharging charge having been detected in the output part.

6. The solid-state image pickup device according to claim 1, wherein the horizontal shift register includes a charge transfer path branched into two on a transfer electrode adjacent to a transfer electrode of a final stage of the horizontal shift register.
